(19) United States
(12) Patent Application Publication
(10) Pub. No.: US 2009/0158653 A1
(43) Pub. Date: Jun. 25, 2009

(54) Hanging Planter

(75) Inventors: Frank F. Oliver, Essex, VT (US); Diane E. Fuchs, Burlington, VT (US)

Correspondence Address: DOWNS RACHLIN MARTIN PLLC, 199 MAIN STREET, P O BOX 190, BURLINGTON, VT, 05402-0190, US

(73) Assignee: AMERICA'S GARDENING RESOURCE, INC., Burlington, VT (US)

(21) Appl. No.: 12/339,159

(22) Filed: Dec. 19, 2008

Related U.S. Application Data
(60) Provisional application No. 61/014,994, filed on Dec. 19, 2007.

(51) Int. Cl. A01G 9/02; A01G 27/00; A01G 27/04

(52) U.S. Cl. 47/66.2; 47/67; 47/66.1; 47/79; 47/81; 47/66.7

(57) ABSTRACT

A hanging planter provides a growing environment that allows a plant to grow in a substantially downward direction. The planter includes a structure with an interior surface that defines an interior chamber. The interior chamber receives a liner made of a material of the type suitable for retaining growing medium therein. The structure and liner include at least one opening that permits the plant to be positioned within the growing medium such that the root structure grows within the interior chamber and the stem portion grows downward without the need for external structure. Optionally, a self-watering system is included.

### RELATED APPLICATION DATA

This application claims the benefit of priority of U.S. Provisional Patent Application Ser. No. 61/014,994, filed Dec. 19, 2007, and entitled “Hanging Planter,” which is incorporated by reference herein in its entirety.

### FIELD OF THE INVENTION

The present invention relates generally to the field of planters. In particular, the present invention is directed to a self-watering hanging planter that may be flipped after the plant is established.

### BACKGROUND

Certain vegetable plants, e.g., tomatoes, peppers, and cucumbers, etc., bear fruit on long stems that are often too weak to stand erect while bearing mature fruit. Without support or with inadequate support, fruit production from such plants may be adversely affected. To increase yields and to prevent damage to the stems of these plants caused by extra weight, gardener's often support the stems in manner that causes the plants to grow in a substantially vertical orientation. Since many plants grow fairly tall, i.e., several tomato varieties generally exceed 3 feet in height, conventional planters, supports and other structures are often too short or too weak to provide adequate support and/or require time consuming repetitive maintenance to sustain the plant in a vertical growing position.

Accordingly, devices for growing plants upside down have been developed. Such “upside-down” planters, if positioned a sufficient height above the ground, will permit a plant to achieve its full size without contacting the ground. In addition, growing plants from a planter in an upside-down position will substantially reduce the need for weeding, while also virtually eliminating the need to stake, tie, or otherwise support heavy vegetable plants. Unfortunately, known upside-down planters suffer from a number of drawbacks that limit their performance.

Known upside-down planters, while solving several problems for today's gardeners, have also created new issues and/or have not fully addressed the functionality necessary for a low-maintenance upside-down planter. Specifically, prior art upside-down planters do not typically make it convenient for the gardener to start a plant from seed or a very small seedling. In addition, prior art planters often do not allow for an adequate plant root establishment in the planter prior to placing the plant in an upside-down position, thereby creating a shallow root system and possibly resulting in less than optimal plant growth. Lastly, prior art upside-down planters tend not to adequately address the regulation and transfer of water to the growing medium or allow for the transfer of water to the growing medium while in both the upside-down and right-side up positions.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a front, perspective, partial break-away view of an exemplary planter in accordance with certain aspects of the present invention;

FIG. 2 is a front, elevation view of the exemplary planter illustrated in FIG. 1;

FIG. 3 is a bottom view of the exemplary planter illustrated in FIG. 1;

FIG. 4 is a front, elevation view of an exemplary planter in an alternate embodiment of the present invention; and

FIG. 5 is a front, elevation view of an exemplary planter in an alternate embodiment of the present invention.

### SUMMARY OF INVENTION

One aspect of the present invention is a hanging planter for growing a plant. The hanging planter comprises a structure that includes an interior chamber and an interior sidewall. The interior chamber has a first portion and a second portion, where the second portion includes at least one aperture for receiving a plant. The hanging planter also comprises a fabric liner in the interior chamber proximate the interior sidewall. The fabric liner is configured and constructed to retain the growing medium therein, and includes at least one opening substantially aligned with the aperture for receiving a plant. The hanging planter also comprises a watering system located at least partially within the first portion, the watering system being sized and configured so as to substantially block the growing medium from escaping from the interior chamber when the interior chamber is positioned so that the second portion is positioned above the first portion. The watering system includes a reservoir for receiving a hydrating liquid therein and a transfer mechanism for transporting the hydrating liquid to the growing medium. The hanging planter also comprises means to support the hanging planter in a substantially vertical position.

Another aspect of the present invention is a planter for growing a plant. The planter comprises a structure that includes an interior chamber having an elongate axis. The interior chamber is configured and constructed to retain a growing medium therein and has a first portion and a second portion, with the second portion including at least one aperture for receiving a plant. The planter also comprises a watering system positionable in the interior chamber. The watering system includes a reservoir for receiving a hydrating liquid therein and a transfer mechanism for transporting the hydrating liquid to the growing medium when the transfer mechanism is positioned to contact the growing medium. The watering system is sized and configured relative to the interior chamber so that when positioned in the interior chamber the watering system is movable along the elongate axis so that as the growing medium compacts over time the watering system may descend into the interior chamber along the elongate axis, thereby maintaining contact between the transfer mechanism and the growing medium.

Another aspect of the present invention is a method of growing a plant. The method comprises filling a planter with a growing medium, with the planter having a structure that may be positioned in an upwardly facing position and a downwardly facing position, planting a plant in the planter, watering the plant using a watering system capable of moderating a transfer of a hydrating liquid to the growing medium, and allowing the watering system to move relative to the planter so that as the growing medium compresses over time the watering system maintains contact with the growing medium.

### DETAILED DESCRIPTION

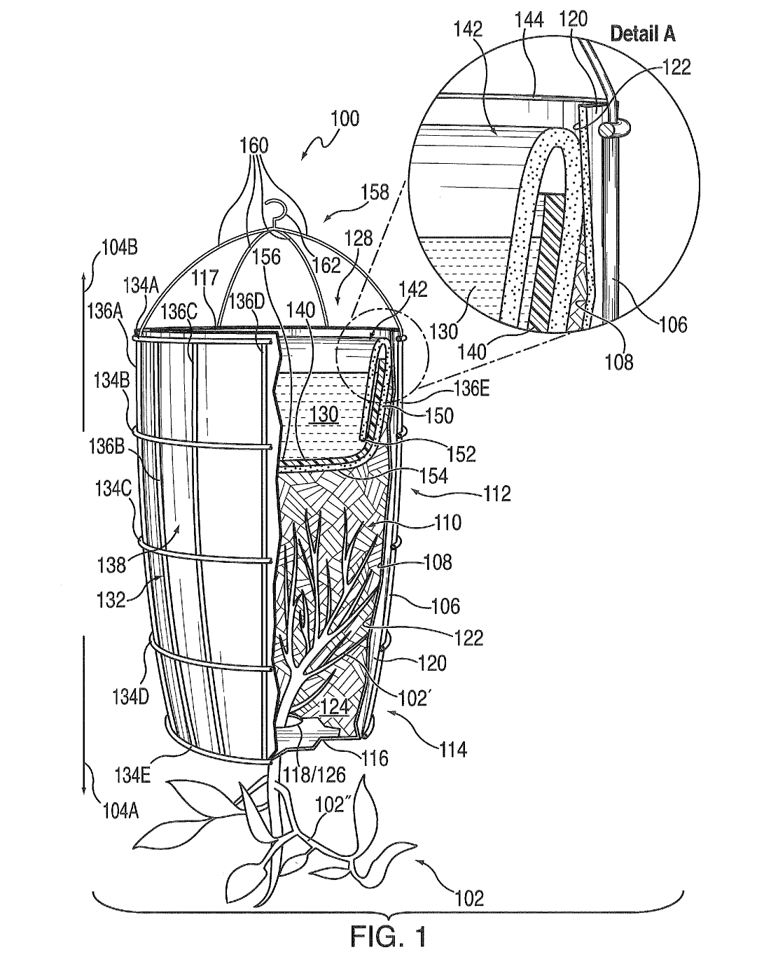

Referring now to the drawings, FIG. 1 illustrates an example of a planter 100 in accordance with certain aspects of the present invention. Generally, planter 100 is an invertible, self-watering planting device of the type suitable to grow a plant 102, e.g., a tomato plant, so that it extends downwardly from the planter. As will be discussed more fully below, planter 100 provides support, nutrients, and moisture to the root structure 102′ of plant 102, while the inverted orientation of the planter permits substantially uninhibited growth of one or more stems 102″ of plant 102. Although just one plant 102 is illustrated growing in planter 100, it is to be appreciated that multiple plants may be grown simultaneously. Additionally, planter 100 is constructed in a manner that provides a user the option of initially growing plant 102 in a substantially upward direction 104B and then inverting the planter to grow plant 102 in substantially downward direction 104A, all without the need to replant or substantially uproot the plant.

While the components of planter 100 will be discussed in greater detail further below, a general description of planter 100 as it relates to FIG. 1 follows. In the present implementation, planter 100 includes a structure 106 that has an interior surface 108 (best seen in Detail A of FIG. 1) that surrounds an interior chamber 110. The interior chamber 110 includes a first portion 112 and a second portion 114 that typically includes a bottom 116. First portion 112 will usually, but not necessarily, terminate at opening 117. Second portion 114 includes at least one aperture 118 (shown in more detail in FIG. 3), typically in bottom 116, that is sized and configured to accommodate at least a portion of stem 102″ of plant 102. In some cases, more than one plant 102 may be positioned in aperture 118. In this regard, aperture 118 is generally sized to accommodate the anticipated mature diameter of stem 102″ and initial foliage of the plant 102, and may be sized to receive more than one plant. Additionally, second portion 114 may include a plurality of apertures (not shown) similar to aperture 118, typically in bottom 116, for receiving a plurality of plants 102.

Planter 100 includes a liner 120 that is positioned inside of interior chamber 110 of structure 106 so as to form a volume 122. Volume 122 receives a plant growing medium 124. A variety of growing mediums suitable for growing plant 102 are known in the art. Exemplary growing mediums include, but are not limited to, soil, fertilized soil, soilless potting mix (e.g., peat, coir, and/or fiber base), alone or with moisture-retaining materials. Volume 122 is also configured in a manner that permits root structure 102′ to grow to a sufficient size to support the foliage and fruit produced by plant 102, assuming suitable nutrition and moisture are provided. An exemplary volume for volume 122 is about 0.6 ft³, although it is contemplated that suitable volumes for planter 100 may typically range from about 0.25 ft³ to about 3 ft³.

As illustrated in FIGS. 1 and 3, liner 120 includes an opening 126 that is substantially aligned with aperture 118 so as to permit plant 102 to grow through the aperture in downward direction 104A. In certain implementations, opening 126 and aperture 118 may be substantially the same size. In other implementations, opening 126 may be larger or smaller than aperture 118. In any event, it will generally be desirable to size opening 126 such that it substantially retards plant growing medium 124 from exiting volume 122.

Planter 100 may optionally include a watering system 128 that is positioned in or proximate first portion 112 of structure 106. Watering system 128 is designed to receive a hydrating liquid 130 for distribution to growing medium 124, and hence to root structure 102′. The hydrating liquid may generally be water, but may also include other nutrients to stimulate plant growth. Preferably, but not necessarily, watering system 128 is positioned on top of growing medium 124 in first portion 112. In one implementation, watering system 128 has a shape and configuration selected to allow it rest on top of growing medium 124 and fit within structure 106 so that as the growing medium compresses with time, watering system 128 is able to move toward second portion 114 and remain in contact with the growing medium. Designing watering system 128 so that it maintains contact with growing medium 124 as the growing medium compacts allows the watering system to supply adequate hydrating liquid 130 to plant 102 over the complete growing cycle of the plant.

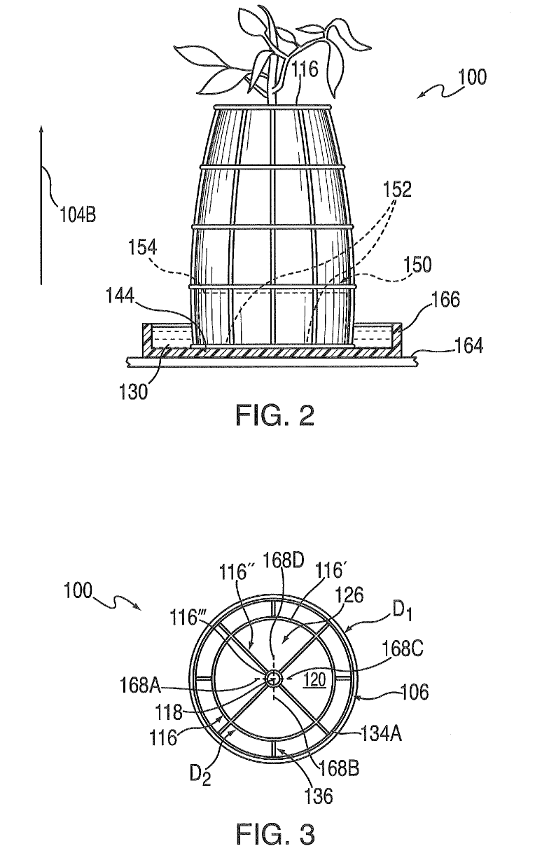

Alternatively, it is contemplated that watering system 128 can be positioned outside of interior chamber 110 in a variety of locations such that hydrating liquid 130 is distributed to growing medium 124. It may also be desirable for watering system 128 to be sized and configured in a manner such that when it is positioned in first portion 112 it substantially prevents growing medium 124 from exiting volume 122 when second portion 114 is positioned above first portion 112, as illustrated in FIG. 2 and discussed more below.

Discussing in more detail the components of planter 100, structure 106 may be constructed of a variety of materials known in the art. Exemplary materials include, but are not limited to, wood and woody grasses (e.g., bamboo), metals (e.g., steel and aluminum), plastics (e.g., polyethylene and polypropylene), fiberglass and composites (e.g., carbon fiber), among others. Other materials may be selected based on one or more desirable physical properties, e.g., strength, stiffness and density. These materials will typically be selected to permit the addition of growing medium 124 having a volume in excess of 0.25 ft³ to interior chamber 110 without collapsing or otherwise failing. Manufacturing costs for planter 100 will often dictate the materials used for structure 106. In one embodiment, structure 106 is made from steel rod having a diameter of about 0.5 centimeters and attached together by welding to form an integral cage-like structure, sometimes referred to as a “hayrack” or hanging wire basket structure, as illustrated in FIG. 1.

Further, structure 106 may have a variety of forms known in the art. In one implementation, structure 106 is illustrated in FIG. 1 with an interior chamber 110 that has a substantially cylindrical configuration with first portion 112 having a diameter slightly larger that second portion 114. Other suitable structures include, for example, cylinders with uniform diameters, cubes and truncated cones of various dimensions, spherical, semi-spherical and oblong (e.g., egg-shaped) structures, as well as other configurations that define a volume 122.

Structure 106 may have one of several different constructions including, for example, a solid shell assembly, a porous frame assembly, a hybrid assembly, as well as other assemblies suited to receive plant 102, liner 120, and watering system 128 as discussed herein. An assembly consistent with a solid shell assembly, for instance, may include a substantially continuous, unbroken interior sidewall 108. An assembly consistent with a porous frame assembly, as discussed in more detail below, may include a substantially porous interior sidewall 108 with one or more openings. An assembly consistent with a hybrid structure may combine each of the solid shell and porous frame assemblies so as to include an interior sidewall 108 with portions that are substantially continuous and portions that include openings. Structure 106 may also provide support for only second portion 114 and liner 120, while liner 120 retains growing medium 124 in first portion 112 without being surrounded by structure 106. In other words, structure 106 may be sized to surround only a portion of the length of liner 120, and not the majority of the length of the liner as indicated in FIG. 1. It may be desirable, for instance, to provide a structure that surrounds only a portion of the length of liner 120 and not the majority of the length of the liner in order to reduce the weight of planter 100 as well as to allow for increased nestability of multiple planter 100's thereby reducing packaging and/or shipping costs of planter 100.

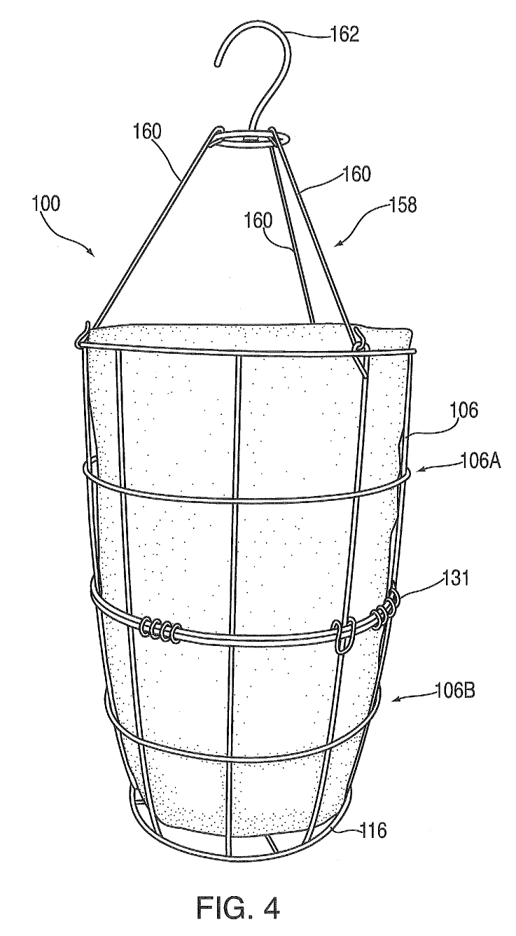

Structure 106 may be rigid or collapsible. In either case, structure 106 may include interior sidewall 108 that incorporates concepts of the previously recited assemblies (e.g., solid shell assembly, porous frame assembly, hybrid assembly). The collapsible assembly, however, may be constructed in a manner that permits substantial, non-permanent modifications to structure 106. It may be desirable, for instance, to provide a collapsible assembly that permits a significant reduction in volume 122 for packaging and/or shipping of planter 100. For example, and as shown in FIG. 4, structure 106 may include two portions, top portion 106A and bottom portion 106B, positioned on opposite sides of a plane extending parallel to bottom 116 and intersecting structure 106 at or near a vertical mid-point of the structure. In one implementation, portions 106A and 106B may be independent structures that are reassembled and held together by a connector 131. Suitable fasteners for connector 131 include adhesives, hook and loop fabric connectors, clamps, bolts, screws, hinged joints, wire coil connectors and other devices suitable for securing together portions 106A and 106B, whether releasably or non-releasably. In an exemplary embodiment, top portion 106A and bottom portion 106 B are sized and configured so that they can be initially nested together (not shown). In this embodiment, top portion 106A and bottom portion 106B are then slide apart to the position illustrated in FIG. 4, with the top portion finally resting on the bottom portion. Top portion 106A and bottom portion 106B are secured together with connector 131.

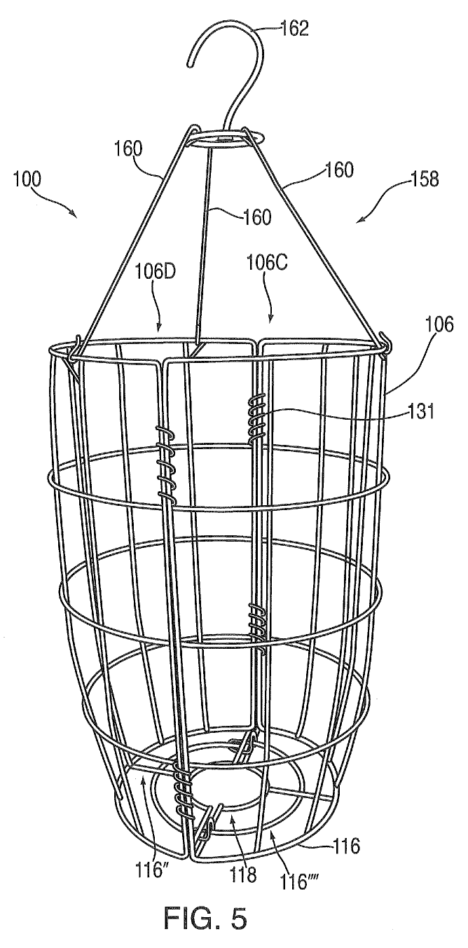

In another example, and as shown in FIG. 5, structure 106 may be divided into two portions, right portion 106C and left portion 106D, positioned on opposite sides of a plane extending perpendicular to bottom 116 and intersecting structure 106 on the central elongate axis of structure 106. In this example, right portion 106C and left portion 106D are substantially the length of the elongate axis of planter 100, and may be reassembled and then held together by connector 131. It is to be appreciated that more subdivisions may be created, reassembled, and connected together via connector 131 to form structure 106. In any event, upon reassembly volume 122 will assume its intended configuration, i.e., prepared to receive one or more of plant 102, liner 120, and/or watering system 128.

In one implementation, structure 106 has a plurality of frame members 132 that include horizontal members 134, e.g., members 134A-E, and vertical members 136, e.g., members 136A-E. Generally, frame members 132 may be fastened in a manner known in the art. Suitable fasteners include, but are not limited to, bolts, screws, hinged joints, and other fasteners recognized in the art. Alternatively, it may be desirable for frame members 132 to be joined permanently, or semi-permanently, in accordance with other fastening methods, such as, welding and/or adhering with a suitable adhesive.

Typically each of frame members 132 may comprise a single, unitary structure. It may be desirable, however, that some or all of the frame members comprise a plurality of smaller structural units that are connected in a manner to form structure 106. Each of the frame members may be connected to form a plurality of openings 138 that have substantially the same size and the same shape. Alternatively, certain implementations of planter 100 may have openings 138 with a variety of sizes and shapes that are consistent with concepts of the present invention.

Bottom 116 may have one of several different constructions that will support liner 120 and/or growing medium 124 as discussed herein, e.g., solid shell assembly, porous frame assembly, hybrid assembly. In one embodiment, bottom 116 is made from steel rod having a diameter of about 0.5 centimeters and attached together by welding to form an integral structure. The embodiment of bottom 116 illustrated in FIG. 3 includes an outer member 116′, radial members 116″, and an interior member 116′″. In this embodiment, interior member 116′″ defines aperture 118. In certain implementations, outer member 116′ may be omitted, with horizontal member 134E fulfilling its function (e.g., when structure 106 is constructed as a plurality of frame members 132 as described herein). In another example, and as shown in FIG. 5, bottom 116 may be composed of a plurality of concentric members, starting at the outer edge of structure 106 and gradually decreasing to substantially the size of aperture 118. In this example, the concentric members 116″″ are attached to each other by radial members 116″. In yet another example, bottom 116 may be a completely solid or substantially solid construction, thus prohibiting most, if not all, of growing medium 124 from escaping interior chamber 110. In any event, bottom 116, when used, may be sized and configured to provide support for growing medium 124, plant 102, and/or liner 120 when planter 100 is positioned in the upside down position, as illustrated in FIG. 1.

As mentioned above, structure 106 is configured to receive liner 120 that supports growing medium 124 and substantially retains it within volume 122. A variety of materials suitable for use as liner 122 are known in the art. When it is desired that liner 120 have a pliable construction, such materials include, for example, woven and non-woven fabrics (e.g., burlap), plastic sheeting and other materials. Typically, although not necessarily, liner 120 is substantially pliable and/or formable so as to assume the shape of structure 106 when positioned in interior chamber 110. In one embodiment, for example, liner 120 is a fabric liner constructed of either woven or non-woven materials suitable for retaining growing medium 124. As used herein and the claims appended hereto, the term woven shall include fabric made or constructed by interlacing threads or strips of material or other elements into a whole. Fabric that is non-woven shall include any material that is not woven, e.g., a film, knit, foam, felt, melt-blown, spunbond, air-laid, cast material, extruded material, and molded material, among others. Liner 120 can obviously comprise any suitable woven or non-woven material or a combination of the two. In other cases, liner 120 may be rigid, with its size and configuration being selected to fit partially or entirely in interior chamber 110.

It may be desirable to fasten liner 120 to structure 106 using one or more techniques. Suitable fasteners include, but are not limited to, cable ties, zip ties, rivets, hooks, and screws. Other fasteners, such as adhesives, may provide an acceptable level of fixation to interior sidewall 108. It is further contemplated that other fastening techniques may be selected in accordance with characteristics of structure 106, such as the techniques discussed above.

In some applications, it may be desirable to combine structure 106 and liner 120 into a unitary structure (not shown). In such a unitary structure, openings 138 are generally either omitted entirely or are sufficiently small that little, if any, growing medium 124 will escape through the openings.

Referring to FIG. 1, including its Detail A, watering system 128 may include a reservoir 140 and a transfer mechanism 142. Generally, reservoir 140 retains hydrating liquid 130. Reservoir 140 has a configuration and construction consistent with retaining liquid. Suitable shapes include, for instance, a cylinder, a square, rectangle, and a frustum, all with a chamber that retains hydrating liquid 130. Referring now to Detail A of FIG. 1, it may also be desirable that the shape and configuration selected for reservoir 140 substantially conforms to the shape of structure 106. That is, reservoir 140 and/or transfer mechanism 142 may be sized and configured in a manner that substantially “plugs” first portion 112 so as to prevent growing medium from escaping from volume 122 past watering system 128 when second portion 114 is positioned above the first portion.

As discussed above in a general sense with respect to watering system 128, reservoir 140 and/or transfer mechanism 142 may also be sized to allow for movement within structure 106 from first portion 112 toward second portion 114. This configuration allows reservoir 140 and/or transfer mechanism 142 to maintain contact with growing medium 124, thereby continuing to provide hydration liquid 130 to plant 102 as the growing medium 124 compresses over time.

Optionally, it may be desirable for reservoir 140 to be secured to structure 106 in a manner that prevents reservoir from being easily removed from planter 100. Reservoir 140 may be fastened to structure 106 using any one of the fastening techniques discussed above. It is further contemplated that certain implementations of planter 100 may include a reservoir 140 with a lip or flange (neither shown) that protrudes above a top edge 144 (see Detail A) of structure 106. In this configuration, reservoir 140 may be secured to the first portion 112 of structure 106 adjacent its opening 117 using fasteners and fastening techniques recognized in the art and/or discussed herein.

Transfer mechanism 142 is configured in a manner that transfers hydrating liquid 130 to growing medium 124. Generally, transfer mechanism 142 controls the amount of hydrating liquid 130 that is provided to growing medium 124 at any one time. Transfer mechanism 142 may be selected so as to release moisture in a manner that permits absorption by growing medium 124, but minimize the incidence of hydrating liquid 130 dripping out of aperture 118. For many applications, it will be desirable to select a transfer mechanism 142 that releases moisture at a rate of transfer that exceeds about 0.25 gallon per day into growing medium 124. In one embodiment of planter 100, transfer mechanism 142 includes a capillary mat 150 with first end 152 in contact with hydrating liquid 130 and a capillary surface 154 in contact with growing medium 124. Materials suitable for use as capillary mat 150 are known in the art. Exemplary materials include, for example, felts, synthetic fabric, paper, cardboard, natural fiber cloth, and other materials that are structured to transfer liquids via capillary action.

Referring to FIG. 1, in one implementation, a single capillary mat 150 is used. Other implementations of planter 100 may include multiple capillary mats that are arranged in a manner that transports hydrating liquid 130 to growing medium 124. In any event, the capillary mats (e.g., capillary mat 150) may be of various quantities, shapes, and sizes, and will generally be selected in accordance with the desired application and/or after experimentation directed at establishing their most effective orientation.

Other transfer mechanisms 142 are contemplated that are in accordance with concepts of the present invention. For example, reservoir 140 in certain implementations of planter 100 may include materials that cause sufficient backpressure so as to control the flow of hydrating liquid 130 into growing medium 124. Such materials include, for example, ceramics, unglazed terra cotta, and porous stone, among others. In one implementation, porous ceramic discs (not shown) may be incorporated in a surface 156 of reservoir 140 in a manner that provides sufficient moisture to growing medium 124. In another implementation, reservoir 140 comprises a ceramic bowl with at least a portion of reservoir surface 156 left unglazed so as to permit hydrating liquid 130 to flow through such portion to growing medium 124.

As an optional feature, certain implementations of planter 100 may include a hanging system 158. Generally, hanging system 158 provides a mechanism for securing planter 100 in an elevated state when plant 102 is growing in the substantially downward direction 104A. A variety of hanging systems 158 will be appreciated by those ordinarily skilled in the art. In one example, hanging system 158 includes a plurality of hang lines 160 and a hook 162. Hang lines 160 may comprise a variety of materials known in the art. Suitable materials include, for example, chains and chain links, rope, cables, wire, rod, elastics, and other materials that are selected in accordance with the weight of planter 100 when full of growing medium 124. Similarly, materials for hook 162 are also selected so as to be compatible with the application of planter 100, as desired. In an alternative configuration, hanging system 158 may include a swivel (not shown) of the type that are known in the art. An exemplary configuration of hanging system 158 may have a swivel positioned between hang lines 160 and hook 162 in a manner that allows a user to rotate planter 100 in accordance with available sunlight. In one embodiment, hanging system 158 may have a hook 162 that also serves as a swivel for planter 100. In one example of this embodiment, and as shown in FIGS. 4 and 5, hang lines 160 are composed of three or more wire rods. Hang lines 160 have bottom ends attached to structure 106 and a top ends attached to a circular disk, which has a slotted hole at or near its center. Hook 162, for most of its length, has a diameter that allows it to slide through the aforementioned slotted hole. One end of hook 162 is expanded to be larger than the slotted hole, thereby preventing passage of hook 162 through the slotted hole. In this configuration, hanging system 158 suspends planter 100 and allows it to swivel when in a substantially vertical position.

As another optional feature of certain implementations of planter 100, it may be desirable to provide bottom 116 as a releasably secured component of structure 106. Here, suitable configurations for bottom 116 may include a hinge or other coupling that permits bottom 116 to be moved in a manner that exposes second portion 114. Alternatively, another suitable configuration for bottom 116 may include releasable fasteners (not shown) that permit bottom 116 to be removed from structure 106. As discussed in more detail below, when bottom 116 is releasably attached it may, in some cases, substantially ease planting of plant 102 in planter 100 as well as allowing plant 102 to receive adequate sunlight and hydrating liquid.

Discussing now the use of planter 100, and with reference to FIGS. 1 and 2, structure 106 is assembled, assuming it is provided in an unassembled or collapsed state. Next, liner 120 is positioned in structure 106 proximate interior sidewall 108 so as to fill much, if not all, of interior chamber 110. Often, but not always, it will be useful to attach liner 120 to structure 106, e.g., using cable ties that connect individual portions of liner 120 to one or more corresponding frame members 132. This step is not required, of course, when structure 106 and liner 120 are formed as a unitary structure, as discussed above. With planter 100 in a substantially horizontal position, a portion (e.g., about half) of interior chamber 110 is filled with growing medium 124. Plant 102 is then inserted through opening 126 and aperture 118, with stem 102″ of plant 102 being positioned at a location in which it hangs freely from planter 100, as shown in FIG. 1. Planter 100 is then oriented such that plant 100 faces in substantially downward direction 104A, and the remaining portion of interior chamber 110 is filled with growing medium 124 to a level that is compatible with the type of plant 102 to be grown, or, alternatively, to a level compatible with the placement of watering system 128.

When watering system 128 is to be used, and transfer mechanism 142 is implemented as one or more capillary mats, capillary surface 154 is positioned on top of growing medium 124, while first end 152 is temporarily positioned over top edge 144 of structure 106. The position of first end 152 permits reservoir 140 to be placed inside first portion 112 proximate the top of growing medium 124. If necessary, reservoir 140 can be secured to structure 106. After reservoir 140 is positioned, first end 152 is positioned inside of reservoir 140 at a location suited for contact with hydrating liquid 130. Hydrating liquid 130 may be added to reservoir 140. It is understood that at one or more times during the growing season replacement of one or more capillary mats 150 may be necessary because of the decreasing effectiveness in transferring hydrating liquid 130.

In the present example, hanging system 158 is secured to structure 106 and to a corresponding hanging position suited for plant 102 to grow in substantially downward direction 104A.

When bottom 116 is releasably attached to structure 106 as discussed above, watering system 128 may be installed before plant 102 and/or prior to filling planter 100 with growing medium 124. In this regard, reservoir 140 and transfer mechanism 142 are positioned inside of interior chamber 110 in first portion 112 when planter 100 is in the position shown in FIG. 1. Then, planter 100 may be flipped over to assume the position shown in FIG. 2, i.e., where second portion 114 is above first portion 112, so as to expose bottom 116. With this approach, it will generally be desirable to position top edge 144 of structure 106 on a surface 164, e.g., the ground.

Bottom 116 is then removed and interior chamber 110 is filled with growing medium 124 through opening 126 in liner 120. Plant 102 may then be planted in growing medium 124 through opening 126. Bottom 116 is then re-positioned so as to orient stem 102″ of plant 102 through aperture 118 before bottom 116 is re-attached to structure 106. Planter 100 is then flipped over such that first portion 112 is above second portion 114, as shown in FIG. 1. Hanging system 158 may be attached, hydrating liquid 128 added, and planter 100 placed in a corresponding hanging position suited for plant 102 to grow in substantially downward direction 104A.

Regardless of whether or not bottom 116 is releasably attached to structure 106, it will sometimes be desirable to allow plant 102 to grow in substantially upwardly direction 104B (FIG. 2) for a period of time, e.g., 2-6 weeks, before planter 100 is flipped so as to permit plant to grow in substantially downward direction 104A (FIG. 1). For example, when starting seeds or seedlings in planter 100 it will often be desirable to position the planter so seedlings grow in upwardly direction 104B for several weeks. This position avoids shading of the seedlings by portions of planter 100 and allows the roots of the seedlings to become established in growing medium 124 before flipping planter from the position shown in FIG. 2 to the position shown in FIG. 1. Prior to such flipping, it may be desirable to provide hydrating liquid 130 to growing medium 124 using a secondary reservoir 166 (FIG. 2). In such a case, top edge 144 of structure 106 is positioned inside of secondary reservoir 166 so as to permit the transfer mechanism to deliver hydrating liquid 130 up into growing medium 124. In the exemplary configuration illustrated in FIG. 2, first end 152 of capillary mat 150 are positioned inside of the space created by reservoir 140 when planter 100 is oriented as illustrated. First end 152 in other exemplary configurations, however, may be positioned so as to extend radially outward toward the edges of secondary reservoir 166. Any of these configurations permits moisture to flow in a manner and at a rate of transfer described above from secondary reservoir 166 into growing medium 124 as plant 102 grows in upwardly direction 104B in relation to bottom 116. In some cases it may be desirable to use micro-drippers (not shown) in place of capillary mat 150.

Plant 102 will eventually reach a stage of growth where it will be desirable to flip planter 100 so that plant 102 can continue its growth cycle in downwardly direction 104A, as illustrated in FIG. 1.

In the example of planter 100 illustrated in FIGS. 1-5, structure 106 has a diameter D1 (FIG. 3) and bottom 116 with a diameter D2 (FIG. 3). As mentioned above, although it is contemplated that D1>D2 (as illustrated in FIGS. 1-5), it may be desirable that certain implementations of planter 100 have dimensions such that D1=D2 or D1<D2. Further, it will be readily appreciated in view of the foregoing discussion that the illustration of planter 100 in FIGS. 1-5 is for exemplary purposes only. It is contemplated that planter 100 in accordance with concepts of the present disclosure may include a variety of configurations, as discussed above.

Opening 126 may be configured as slits 168, e.g., slits 168A-D, (see FIG. 3) that are arranged so as to provide a flexibly movable section of liner 120 that permits stem 102″ to inserted into aperture 118. Slits 168 are also formed to allow them to be positioned in a manner that retards the growing medium from exiting planter 100 through aperture 118. It will be recognized, however, that a variety of suitable configurations of opening 126 are possible while falling within the scope, spirit, and concepts of the present invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A hanging planter for growing a plant, said hanging planter comprising:
a structure that includes an interior chamber and an interior sidewall, said interior chamber having a first portion and a second portion, said second portion including at least one aperture for receiving a plant;
a fabric liner in said interior chamber proximate said interior sidewall, said fabric liner configured and constructed to retain said growing medium therein, said fabric liner including at least one opening substantially aligned with said aperture for receiving a plant;
a watering system located at least partially within said first portion, said watering system sized and configured relative to said first portion so as to substantially block said growing medium from escaping from said interior chamber when said interior chamber is positioned so that said second portion is positioned above said first portion, said watering system including a reservoir for receiving a hydrating liquid therein and a transfer mechanism for transporting said hydrating liquid to said growing medium; and
means to support said hanging planter in a substantially vertical position.

2. A hanging planter according to claim 1, wherein said structure includes a plurality of openings.

3. A hanging planter according to claim 2, wherein said structure includes a hayrack, said hayrack having a plurality of horizontal and vertical members connected together so as to define said plurality of openings.

4. A hanging planter according to claim 1, wherein said structure includes first and second portions forming a collapsible assembly.

5. A hanging planter according to claim 1, wherein said structure further comprises a bottom.

6. A hanging planter according to claim 5, wherein said bottom is configured and constructed so that said bottom is releasably secured to said structure.

7. A hanging planter according to claim 1, wherein said watering system is sized and configured so that said transfer mechanism delivers said hydrating liquid to said growing medium, when present in said fabric liner, when said second portion is above said first portion.

8. A hanging planter according to claim 7, wherein said transfer mechanism has portions that contact said growing medium when said growing medium is present in said fabric liner, said portions being sized and configured so as to permit the transfer of said hydrating liquid to said growing medium.

9. A hanging planter according to claim 1, wherein said transfer mechanism provides said hydrating liquid to the growing medium at rate of at least 0.25 gal/day.

10. A hanging planter according to claim 1, wherein said transfer mechanism is a capillary mat.

11. A planter for growing a plant, said planter comprising:
a structure that includes an interior chamber having an elongate axis, said interior chamber configured and constructed to retain a growing medium therein and having a first portion and a second portion, said second portion including at least one aperture for receiving a plant; and
a watering system positionable in said interior chamber, said watering system including a reservoir for receiving a hydrating liquid therein and a transfer mechanism for transporting said hydrating liquid to said growing medium when said transfer mechanism is positioned to contact said growing medium, wherein said watering system is sized and configured relative to said interior chamber so that when positioned in said interior chamber said watering system is movable along said elongate axis so that as said growing medium compacts over time said watering system may descend into said interior chamber along said elongate axis, thereby maintaining contact between said transfer mechanism and said growing medium.

12. A planter according to claim 11, wherein said interior chamber includes an interior sidewall and said structure includes a fabric liner in said interior chamber proximate said interior sidewall, said fabric liner configured and constructed to retain said growing medium therein, said fabric liner including at least one opening substantially aligned with said at least one aperture for receiving a plant.

13. A planter according to claim 12, wherein said structure includes a plurality of openings.

14. A planter according to claim 13, wherein said structure includes a hayrack, said hayrack having a plurality of horizontal and vertical members connected together so as to define said plurality of openings.

15. A planter according to claim 14, wherein said structure further comprises a bottom.

16. A planting according to claim 15, wherein said bottom is configured and constructed so that said bottom is releasably secured to said structure.

17. A planter according to claim 11, wherein said watering system is sized and configured so that said transfer mechanism delivers said hydrating liquid to said growing medium when said second portion is above said first portion.

18. A method of growing a plant, comprising the steps of:
filling a planter with a growing medium, said planter having a structure that may be positioned in an upwardly facing position and a downwardly facing position;
planting a plant in said planter;
watering said plant using a watering system capable of moderating a transfer of a hydrating liquid to said growing medium; and
allowing said watering system to move relative to said planter so that as said growing medium compresses over time said watering system maintains contact with said growing medium.

19. The method of growing a plant according to claim 18, wherein said watering step is performed when said planter is in said upwardly facing position.

20. The method of growing a plant according to claim 18, wherein said watering step is performed when said planter is in said downwardly facing position.
